(19) United States
(12) Patent Application Publication
(10) Pub. No.: US 2021/0170873 A1
(43) Pub. Date: Jun. 10, 2021

(54) POWER SUPPLY SYSTEMS AND METHODS FOR VEHICLES

(71) Applicants: Michael ANDREWS, Abbotsford (CA); Tiger Tool International Incorporated, Abbotsford (CA)

(72) Inventor: Michael Andrews, Bellingham, WA (US)

(21) Appl. No.: 15/734,383

(22) PCT Filed: Jun. 4, 2019
(86) PCT No.: PCT/US19/35444

§ 371 Date: Dec. 2, 2020

Related U.S. Application Data
(60) Provisional application No. 62/680,485, filed on Jun. 4, 2018.

(51) Int. Cl. B60L 1/12; B60L 50/15; B60R 16/03; B60R 16/033

(52) U.S. Cl. CPC B60L 1/12; B60R 16/033; B60R 16/0307; B60L 50/15

(57) ABSTRACT

A vehicle comprises a motor, a power supply, a load, and a fuel system. The power supply system comprises a DC bus, a turbine generator operatively connected to the DC bus, and a battery system operatively connected to the DC bus. The load is operatively connected to the DC bus. The fuel system supplies fuel to the motor and the turbine generator. The turbine generator supplies a power signal to the DC bus based on fuel from the fuel system. The motor operates based on fuel from the fuel system.

### RELATED APPLICATIONS

This application (Attorney's Ref. No. P219723us) is a 371 of International PCT Application No. PCT/US2019/035444, currently pending.

International PCT Application No. PCT/US2019/035444 claims benefit of U.S. Provisional Application Ser. No. 62/680,485 filed Jun. 4, 2018, now expired.

The contents of all related applications are incorporated herein by reference.

### BACKGROUND

The present application relates to power supply systems and methods and, in particular, to power supply systems and methods adapted for use on vehicles.

Utility power is typically made available as an AC power signal distributed from one or more centralized sources to end users over a power distribution network. However, utility power is unavailable for certain structures. For example, movable structures such vehicles do not have access to utility power when moving and can be connected to the utility power distribution network when parked only with difficulty. Similarly, remote structures such as cabins and military installations not near the utility power distribution network often cannot be practically powered using utility power.

DC power systems including batteries are often employed to provide power when utility power is unavailable. For example, trucks and boats typically employ a DC power system including a battery array to provide power at least to secondary vehicle electronics systems such as communications systems, navigation systems, ignition systems, heating and cooling systems, and the like. Shipping containers and remote cabins that operate using alternative primary power sources such as solar panels or generators also may include DC power systems including a battery or array of batteries to operate electronics systems when primary power is unavailable. Accordingly, most modern vehicles and remote structures use battery power sufficient to operate, at least for a limited period of time, electronics systems such as secondary vehicle electronics systems.

The capacity of a battery system used by a vehicle or remote structure is typically limited by factors such as size, weight, and cost. For example, a vehicle with an internal combustion engine may include a relatively small battery to start the engine and/or for use when the engine is not operating. A large battery array may be impractical for vehicles with an internal combustion engine because the size of the batteries takes up valuable space and the weight of the batteries reduces vehicle efficiency when the vehicle is being moved by the engine. All electric vehicles have significantly greater battery capacity, but that battery capacity is often considered essential for the primary purpose of moving the vehicle, so the amount of battery capacity that can be dedicated to secondary vehicle electronics systems is limited. Battery systems employed by remote structures must be capable of providing power when the alternative power source is unavailable, but factors such as cost, size, and weight reduce the overall power storage capacity of such systems.

Heating and cooling systems have substantial energy requirements. Vehicles such as trucks or boats typically rely on the availability of the internal combustion engine when heating or cooling is required. When heating or cooling is required when the vehicle is parked (or the boat is moored) for more than a couple of minutes, the internal combustion engine will be operated in an idle mode solely to provide power to the heating and cooling system. Engine idling is inefficient and creates unnecessary pollution, and anti-idling laws are being enacted to prevent the use of idling engines, especially in congested environments like cities, truck stops, and harbors. For remote structures such as cabins or shipping containers, heating and cooling systems can be a major draw on battery power. Typically, an alternative or inferior heating or cooling source such as a wood burning stove, fans, or the like are used instead of a DC powered heating and cooling system.

The need thus exists for power supply systems and methods capable of augmenting battery power in a vehicle or remote structure.

### SUMMARY

The present invention may be embodied as a vehicle comprising a motor, a power supply, a load, and a fuel system. The power supply system comprises a DC bus, a turbine generator operatively connected to the DC bus, and a battery system operatively connected to the DC bus. The load is operatively connected to the DC bus. The fuel system supplies fuel to the motor and the turbine generator. The turbine generator supplies a power signal to the DC bus based on fuel from the fuel system. The motor operates based on fuel from the fuel system.

The present invention may also be embodied as a power supply system for a vehicle comprising a motor, a load, a fuel tank, and a primary fuel line for supplying fuel from the fuel tank to the motor, the power supply system comprising a DC bus, a turbine generator, and a battery system. The DC bus is operatively connected to the load. The turbine generator is operatively connected to the DC bus. The battery system is operatively connected to the DC bus. The turbine generator supplies a power signal to the DC bus based on fuel from the fuel system.

The present invention may also be embodied as a method of forming a vehicle comprising the following steps. A motor and a fuel tank are supported on a frame. A power supply system comprising a DC bus, a turbine generator operatively connected to the DC bus, and a battery system operatively connected to the DC bus are provided. A load is operatively connected to the DC bus. Fuel from is supplied from the fuel tank to the motor. Fuel is supplied from the fuel tank to the turbine generator. The turbine generator is operated to supply a power signal to the DC bus based on fuel supplied to the turbine generator from the fuel tank. The motor is operated based on fuel from the fuel system.

The present invention may also be embodied as a method of supplying electrical power to a vehicle comprising a motor, a load, a fuel tank, and a primary fuel line for supplying fuel from the fuel tank to the motor comprising the following steps. A DC bus is operatively connected to the load. A turbine generator is operatively connected to the DC bus. A battery system is operatively connected to the DC bus. The turbine generator operated to supply a power signal to the DC bus based on fuel from the fuel system.

### BRIEF DESCRIPTION OF THE DRAWINGS

FIG. 1 is a side elevation view of an example vehicle employing a first example power supply system of the present invention; and

FIG. 2 is a block diagram illustrating the interaction of the first example power supply system with the example vehicle of FIG. 1.

### DETAILED DESCRIPTION

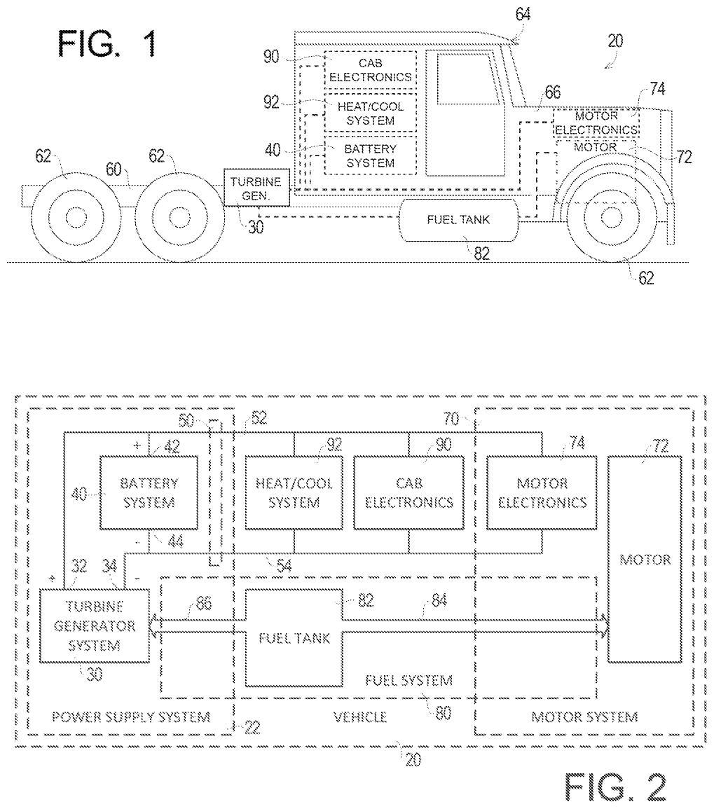

FIGS. 1 and 2 of the drawing depict an example vehicle 20 on which is mounted a first example power supply system 22. As shown in FIG. 2, the example power supply system 22 comprises a turbine generator system 30 defining positive and negative terminals 32 and 34, a battery system 40 defining positive and negative terminals 42 and 44, and a DC bus 50 comprising a first bus connector 52 and a second bus connector 54. The positive terminals 32 and 42 are electrically connected to the first bus conductor 52, and the negative terminals 34 and 44 are electrically connected to the second bus connector 54.

The example vehicle 20 is or may be conventional and comprises a frame 60, wheels 62, a cab 64, and an engine compartment 66. The wheels 62 are rotatably supported by the frame 60. The cab 64 is rigidly supported by the frame 60 when the vehicle 20 is moving. The example turbine generator system 30 is typically supported by the frame 60 outside of the cab 64. The example battery system 40 is typically located within the cab 64 and/or the engine compartment 66.

The example vehicle 20 further comprises a motor system 70 comprising a motor 72 and motor electronics 74. The motor 72 is mechanically connected to at least one of the wheels 62 such that operation of the motor 72 rotates at least one of the wheels 62 to propel the vehicle 20. The motor electronics 74 are operatively connected to the DC bus 50. Typically, the motor electronics 74 will include control devices (not shown) such as sensors, microprocessors, and actuators and an alternator (not shown) configured to supply power to the DC bus 50 when the motor 72 is running.

The example vehicle 20 further operatively comprises a fuel system 80 comprising a fuel tank 82, a main fuel line 84, and a secondary fuel line 86. The main fuel line 84 allows fuel to flow from the fuel tank 82 to the motor 72, while the secondary fuel line 86 allows fuel to flow from the fuel tank 82 to the turbine generator system 30. The fuel system 80 will typically further include control devices such as pumps, valves, and sensors (not shown) configured to ensure that an adequate amount of fuel is delivered to the motor 72 and/or the turbine generator system 30 as appropriate. The example fuel tank 82 is typically supported by the frame 60 outside of the cab 64.

FIGS. 1 and 2 further illustrate that the example vehicle 22 further comprises cab electronics 90 and a heating/cooling system 92. The example cab electronics 90 includes electronics not integral to the functioning of the motor system 70, such as communications equipment, audio/visual equipment, and navigation equipment. The example heating/cooling system 92 comprises a compressor and condenser (not shown) and associated conduits and controls capable of heating and/or cooling the cab 64 of the vehicle 22. The cab electronics 90 and the heating/cooling system 92 are typically mounted partly within and partly outside of the cab 64.

As shown and described above, the turbine generator system 30 is configured to generate a DC signal across the positive terminal 32 and negative terminal 34 based on fuel flowing from the fuel tank 82 through the secondary fuel line 86. The positive terminal 32 and negative terminal 34 are in turn connected to the first and second conductors 52 and 54, respectively, of the DC bus 50. The turbine generator system 30 thus creates a DC power signal capable of providing power to electronics operatively connected to the DC bus 50. Typically, the DC power signal generated by the turbine generator system 30 is used to charge the battery system 40 and/or supply power to any one, two, or all of the motor electronics 74, the cab electronics 90, and the heat/cool system 92.

Typically, the turbine generator system 30 will generate the DC power signal when operation of the motor system 70 is undesirable. For example, when the example vehicle 20 is parked, the motor system 70 is typically switched off (e.g., to conform to anti-idling laws) and the turbine generator system 30 will be turned on such that the DC power signal is present on the DC bus allowing the heating/cooling system 92 to heat or cool the cab 64 and or the operator to have access to the cab electronics. The turbine generator system 30 is also capable of charging the battery system 40 with the motor system 70 switched off.

The present invention is of particular significance when the fuel system 80 is configured to store and supply diesel fuel to the motor system 70. In this case, the turbine generator system 30 is configured to operate using diesel fuel stored in the fuel system 80 to obviate the need for a separate source of fuel for the turbine generator system 30.

The example turbine generator system 30 includes both a turbine generator (not shown) and a rectifier (not shown) for converting the alternating current output of the turbine generator into a DC power signal appropriate for the DC bus 50. Accordingly, the example turbine generator system 30 generates a DC power signal directly applicable to the DC bus 50 to which the battery system 40, motor electronics 74, cab electronics 90, and/or heat/cool system 92 are connected. Alternatively, one or more DC-DC converters may be employed to alter (increase or decrease) the DC voltages from the voltage on the DC bus 50.

Further, some vehicle electronics (e.g., brushless motor) may require an AC input. For example, the heat/cool system 92 may incorporate a brushless motor that operates based on an AC power signal. Typically, the brushless motor incorporates a driver (not shown) that converts a DC power signal into an appropriate AC power signal. Alternatively, a driver incorporating a DC-AC converter may be arranged between the DC bus 50 and the AC vehicle electronics. As yet another alternative, the turbine generator and AC vehicle electronics may be configured so that the AC output of the turbine generator is directly applicable to the AC vehicle electronics without conversion to DC, effectively bypassing the DC bus 50.

What is claimed is:

1. A vehicle comprising:
a motor;
a power supply system comprising
a DC bus,
a turbine generator operatively connected to the DC bus, and
a battery system operatively connected to the DC bus;
a load operatively connected to the DC bus, where the load is at least one of cab electronics and a heat/cool system; and
a fuel system for supplying fuel to the motor and the turbine generator; whereby
the turbine generator supplies a power signal to the DC bus based on fuel from the fuel system; and
the motor operates based on fuel from the fuel system.

2. A vehicle as recited in claim 1, in which the fuel system comprises:
a fuel tank;
a primary fuel line connected between the fuel tank and the motor; and
a secondary fuel line connected between the fuel tank and the turbine generator.

3. A vehicle as recited in claim 1, in which the load at comprises the cab electronics and the heat/cool system.

4. A power supply system for a vehicle comprising a motor, cab electronics, a heat/cool system, a fuel tank, and a primary fuel line for supplying fuel from the fuel tank to the motor, the power supply system comprising:
a DC bus operatively connected to the cab electronics and the heat/cool system;
a turbine generator operatively connected to the DC bus; and
a battery system operatively connected to the DC bus; whereby
the turbine generator supplies a power signal to the DC bus based on fuel from the fuel system.

5. A power supply as recited in claim 4, further comprising a secondary fuel line operatively connected between the fuel tank and the turbine generator for supplying fuel from the fuel tank to the turbine generator.

6. A method of forming a vehicle comprising the steps of:
supporting a motor and a fuel tank on a frame;
providing a power supply system comprising
a DC bus,
a turbine generator operatively connected to the DC bus, and
a battery system operatively connected to the DC bus;
operatively connecting at least one of cab electronics and a heat/cool system to the DC bus;
supplying fuel from the fuel tank to the motor;
supplying fuel from the fuel tank to the turbine generator;
operating the turbine generator to supply a power signal to the DC bus based on fuel supplied to the turbine generator from the fuel tank; and
operating the motor based on fuel from the fuel system.

7. A method as recited in claim 6, in which:
the step of providing fuel from the fuel tank to the motor comprises the step of operatively connecting a primary fuel line between the fuel tank and the motor; and
the step of providing fuel from the fuel tank to the turbine generator comprises the step of operatively connecting a secondary fuel line between the fuel tank and the turbine generator.

8. A method as recited in claim 6, in which the DC bus is operatively connected to the cab electronics and the heat/cool system.

9. A method of supplying electrical power to a vehicle comprising a motor, cab electronics, a heat/cool system, a fuel tank, and a primary fuel line for supplying fuel from the fuel tank to the motor comprising the steps of:
operatively connecting a DC bus to at least one of the cab electronics and then heat/cool system;
operatively connecting a turbine generator to the DC bus; and
operatively connecting a battery system to the DC bus;
operating the turbine generator to supply a power signal to the DC bus based on fuel from the fuel system.

10. A method as recited in claim 9, further comprising the steps of:
operatively connecting a secondary fuel line between the fuel tank and the turbine generator;
supplying fuel from the fuel tank to the turbine generator through the secondary fuel line.
